(19) United States
(12) Patent Application Publication
(10) Pub. No.: US 2019/0172595 A1
(43) Pub. Date: Jun. 6, 2019

(54) STICKY NEUTRON MODERATOR CORE PELLETS

(71) Applicant: US Department of Energy, Washington, DC (US)

(72) Inventor: Donald R. Lambert, Livermore, CA (US)

(21) Appl. No.: 15/920,740

(22) Filed: Mar. 14, 2018

Related U.S. Application Data
(60) Provisional application No. 62/593,298, filed on Dec. 1, 2017.

(51) Int. Cl. G21C 7/24; G21C 21/18

(52) U.S. Cl. CPC G21C 7/24; G21Y 2004/101; G21C 21/18

(57) ABSTRACT

Exemplary embodiments of the present invention comprise pellets comprised of neutron moderating or absorbing materials with a polymer coating. The neutron core moderator pellet 100 comprises a core matrix of neutron absorbing material 102 and a polymer coating 104 that can also serve as a binder for the core 102. The neutron moderating/absorbing material 102 can be selected from a variety of chemical element materials that have been proven to have established neutron capture/absorbing capabilities.

### BACKGROUND OF THE INVENTION

### Field of the Invention

This invention relates to field of nuclear radiation contamination cleanup.

### Description of the Background

A recent nuclear power plant accident has brought to light significant challenges relating to the cleanup and waste management of radioactive materials at accident sites. These issues include, but are not limited to the following: the processing of large volumes of contaminated water, debris, soil, secondary wastes, potentially damaged spent fuel within reactor spent fuel pools, and damaged fuel and fuel debris within reactors and primary containment structures.

After progress has been made in the cooling of the reactors at an accident site mid-term to long-term waste management issues will continue to be a major technical concern that must be addressed and overcome as any recovery actions continue toward an acceptable end state. As such, there are considerable waste management challenges associated with the treatment of contaminated water, the resulting filter and equipment waste storage, the disposal of secondary waste, contaminated soil, vegetation, and debris decontamination.

### SUMMARY OF THE INVENTION

The shortcomings of the prior art are overcome and additional advantages are provided through the provision of a neutron absorbing decontamination pellet that comprises an innermost core of a predetermined neutron absorbing material and an insoluble polymer coating that forms a continuous outer casing for the core of neutron absorbing material. Further, the outer casing decontamination pellet will become sticky, yet retain its integrity, upon exposure to water or upon exposure to a predetermined temperature range.

A further exemplary embodiment of the present invention comprises a method for the formation of neutron absorbing decontamination pellets. The method comprises the steps of; creating a slurry comprising a predetermined neutron absorber material and a binding agent; transporting the slurry through a feeder hose, the hose terminating at a deposit nozzle; employing the deposit nozzle to form the slurry into neutron cores of predetermined sizes; immersing the neutron cores formed by the deposit nozzle into a bath of a predetermined insoluble polymer solution to create an outer casing upon each immersed neutron core in order to construct a neutron absorbing decontamination pellet; and exposing the neutron absorbing decontamination pellets to air to dry, and thereafter transferring the dry decontamination pellets to storage.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a cross-section view of a neutron moderator pellet.

FIG. 2 illustrates an apparatus for the formation of neutron moderator pellets.

FIG. 3 illustrates a nuclear reactor container with the melted remains of a nuclear fuel element assembly.

FIG. 4 illustrates a close-up view of the neutron moderator pellets upon the application of the neutron moderating pellets to the melted nuclear fuel elements.

FIG. 5A illustrates a contaminated structure and the delivery of a neutron moderator pellet application onto the contaminated surface of the structure.

FIG. 5B illustrates a congealed coating of neutron moderator pellet material being removed from the contaminated structure.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views. Herein, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of a referenced item.

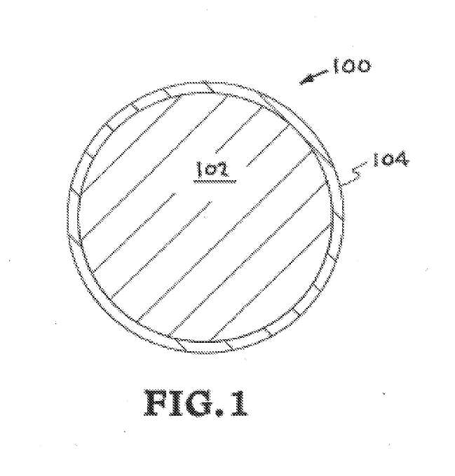

Exemplary embodiments of the present invention comprise pellets fabricated from neutron moderating/absorbing materials that are coated with a water insoluble polymer. As shown in FIG. 1, the neutron core moderator pellet 100 comprises a core matrix of a neutron absorbing material 102 and a polymer coating 104 that in some instances can serve as a binding agent for the construction of the core 102. The neutron moderating/absorbing core material 102 can be selected from a variety of chemical element materials that have been proven to exhibit established neutron capture/absorbing capabilities. For example, such materials could comprise (but are not limited to) boron, hafnium, silver, indium, cadmium, cobalt, samarium, europium, ytterbium, dysprosium, erbium, holmium, thulium, terbium, and gadolinium. The neutron moderating/absorbing core material 102 can also comprise a compound or alloy, e.g., titanium diboride, boron carbide, silver-indium-cadmium alloy, zirconium diboride, and gadolinium titanate.

As presented above, the pellets 100 within the exemplary embodiments of the present invention have a core 102 comprising a predetermined neutron moderating material and an outer shell coating 104 that is comprised of a predetermined polymer material. The polymer chosen to comprise the outer shell 104 must have the intrinsic property of being insoluble in water and being semi-rigid to rigid in structure when exposed to air. The semi-rigid to rigid hard coating of the outer shell 104 is necessitated to facilitate the storage and transportation of the neutron core moderator pellets 100.

The polymer coating employed within the exemplary embodiments of the present invention can have slowly degradable water insoluble, poor water soluble, or partial water soluble characteristics depending upon the area of usage in which the pellets 100 will be deployed and the ambient temperature range within the area of usage. Thus pellets configured with a degradable poor or partial water soluble polymer coating 104 can be configured to become tacky or sticky when introduced to water yet still retain their structural integrity. Further, pellets 100 compromising a water insoluble polymer coating can be constructed to retain their hard shell structural integrity in water until introduced to high temperatures ranges (any temperatures approximately above 60° C.) and thereafter become tactilely tacky or sticky.

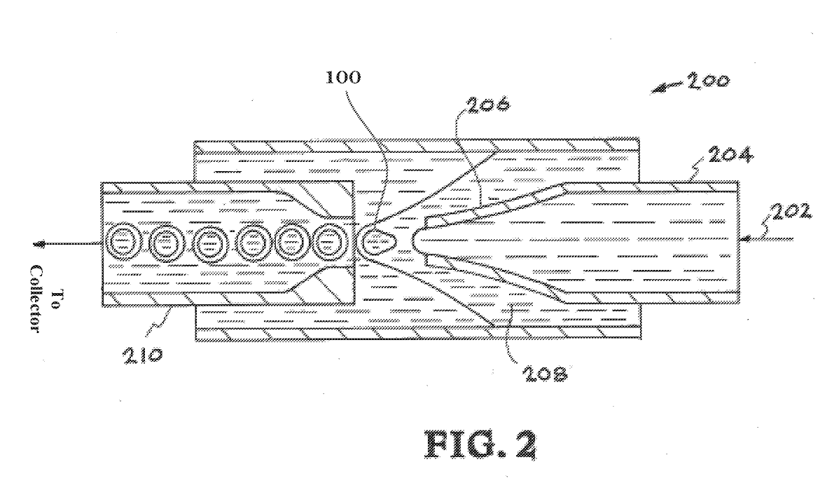

FIG. 2 illustrates a system for forming neutron moderating pellets. A hopper configuration 200 is shown that tapers downward and the materials deposited within the hopper 200 are gravitationally transported through and discharged at the bottom of the hopper 200. Within exemplary embodiments a slurry mixture 202 comprised of a neutron moderating material and a binding agent 202 are deposited into a storage cylinder 204 that is configured with a nozzle 206 that is used to form the pellets 100. The binding agent for the slurry mixture 202 is selected based upon the binder substance comprising a density that that is higher than the polymer coating 104 that is used to construct the pellets 100. The binder holds the neutron moderating/absorbing material together and allows for the moderating material to harden once the pellet core 102 formed from the slurry mixture 202 has cured. Within exemplary embodiments of the present invention the pellet 100 forming nozzle 206 has the capacity to be adjusted to predetermined dispensing settings in order to change the size of pellets 100 that are expelled from the storage cylinder 204, depending on the type of pellet that is necessitated.

The pellet 100 forming nozzle 206 deposits the formed neutron moderator cores 102 into a bath of a predetermined pellet 100 outer coating polymer 208. The characteristics necessitated by the polymer to be utilized will depend on the type of pellet 100 that is to be produced. For pellets 100 that are to be utilized in high temperature settings the pellets 100 can comprise a hard thermoplastic polymer shell at ambient temperatures-thus making the storage and transport of said pellets 100 relatively easy—wherein upon exposure to high temperatures the hard thermoplastic polymer shell will soften and become tacky, thus making it easier for the pellet 100 to adhere to whatever surface it is being applied to whether in an aqueous or dry environment. Also, since the pellets 100 will start to harden again when the temperature of the pellets 100 lowers, the ease of cleaning up the pellets 100 will be greatly enhanced.

Alternately, for pellets 100 that are to be applied to surfaces at or around ambient temperatures, the polymer 104 selected to coat the core 102 will have the characteristic of remaining solid yet pliably tacky or sticky at ambient temperatures while allowing the core 102 of the pellet 100 to completely dry and cure. In this instance the pellets 100 can be stored in a liquid stasis for the convenient storage and transportation of the pellets 100.

Within the hopper 200 the liquid neutron moderator pellet 100 and the polymer 208 are not miscible, thus within the polymer coating 208 solution of the hopper 200 the denser neutron moderating material does not mix with the less dense polymer material. As the neutron modulating pellets 100 are pulled by gravity to the lowermost portion of the polymer outer coating 208 solution each pellet is subsequently bathed in the polymer solution 208. As the pellets 100 exit the formation segment 210 of the hopper 200 they are deposited into a collector (not seen). The coating of the pellets 100 dry once they are exposed to air upon exiting the formation container and the coating solidifies around their neutron moderator cores 102 prior to the pellets 100 landing in the remotely situated collection container.

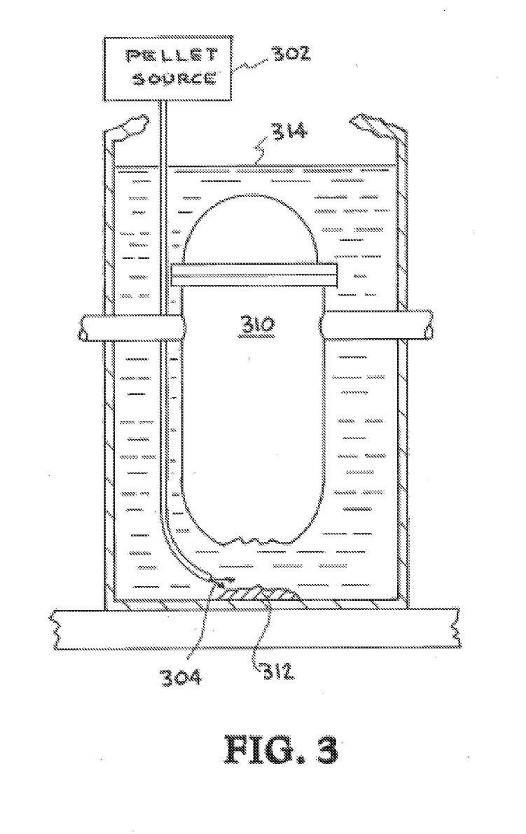

FIG. 3 shows a nuclear reactor vessel 310 wherein the melted remains of the unit's fuel element assembly 312 are pooled on the floor of the reactor vessel. Coolant water 314 has been supplied via coolant pipes in order to cool the melted remains of the fuel elements 312. In this example a neutron moderating pellet delivery system 302 is shown, the delivery system 302 comprising a pellet 100 storage unit and delivery mechanism. Depending upon the emergency service, the water insoluble or partially soluble neutron moderating pellets 100 can be deposited directly upon the melted fuel element 312 in either a dry form or as part of a previously prepared water slurry mixture 304 (the dry pellets will form a slurry mixture 304 with the coolant water 314 upon being deposited onto the melted fuel elements 312 that are immersed within the coolant water 314).

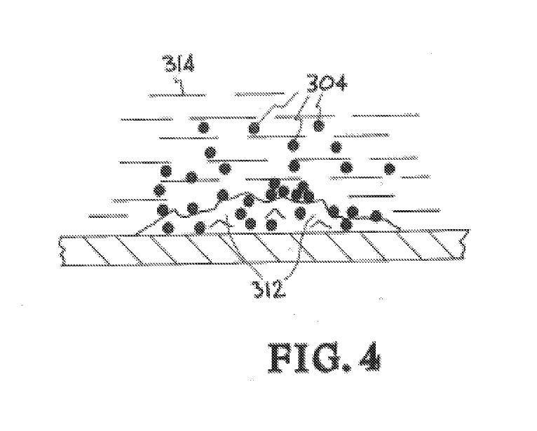

In either form, the pellets 100 are or would become tacky/sticky upon being introduced to the water 314 and fuel elements 312 and as such will easily adhere to the surface of the melted fuel elements 312 when deposited at the site and slow any reactions that may be occurring with the damaged fuel elements 312 (FIG. 4). Any pellets 100 that have not adhered to the surface of the melted fuel element 312 will be suspended in the aqueous slurry mixture 304 and being that they are in the proximity of the melted fuel element 312 the suspended pellets 100 will absorb any resulting radiation and thus slow the reaction occurring within the nuclear fuel elements. Additionally, since the neutron modulating pellets 100 can be produced in a variety sizes ranging from the micro to macro, the pellets 100 can be sufficiently sized so that they can penetrate and adhere to any fissures that may have occurred within the damaged nuclear reactor core materials.

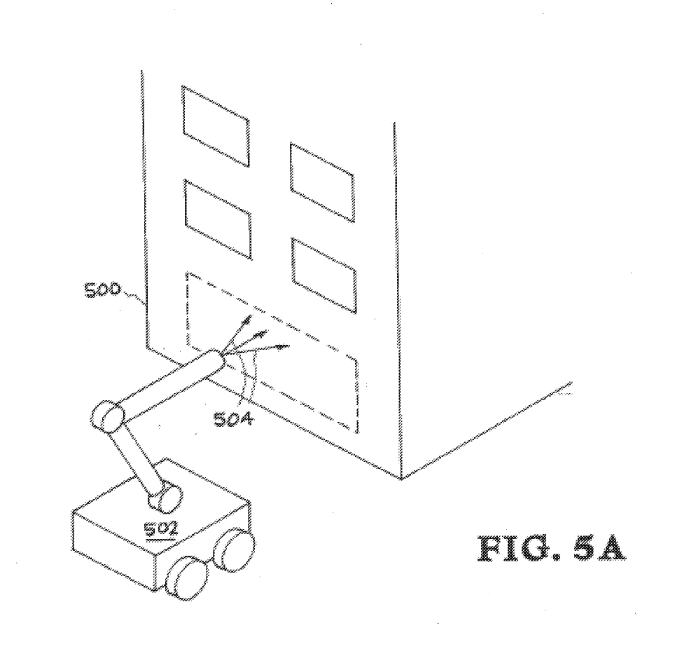

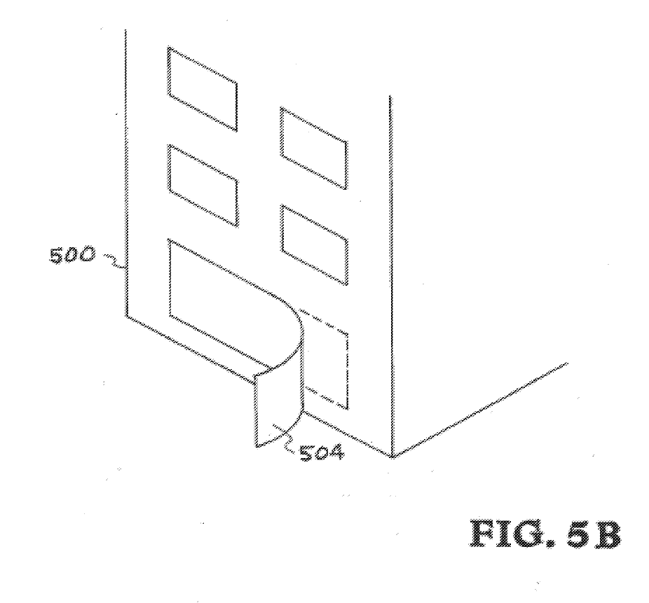

FIGS. 5A and 5B illustrate a further exemplary embodiment of the present invention detailing the delivery of a neutron moderator pellet 100 application onto the surface of a contaminated structure 500. In this example a contaminated structure 500 is approached by a remotely controlled vehicle 502. The vehicle is equipped to carry a supply of the neutron modulator pellets 100 that have been suspended in a gel-solution 504. In this embodiment the neutron modulator pellets 100 are configured into elongated fiber strand shaped pellets 102 encased within the polymer coating 104 and thereafter mixed into the gel solution 504.

The gel-solution is formulated to congeal upon coming into contact with air. Thus, as the gel-solution 504 containing the neutron modulating pellet strands 100 is sprayed onto a patch of contaminated wall the sprayed material will coagulate and form a thin cover over the sprayed patch of contaminated structural area. The congealing gel 504 serves to entrap and absorb the resulting radiation from the contaminated particles beneath it on the wall whereon the gel has been sprayed. The congealed gel covering can be removed from the wall and disposed of in a safe manner at a later period of time.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims.

What is claimed:

1: A neutron absorbing decontamination pellet comprising:
an innermost core comprised of a predetermined neutron absorbing material; and
an insoluble polymer coating forming a continuous outer casing for the core of neutron absorbing material.

2: The decontamination pellet of claim 1, wherein the neutron core material can be configured into a predetermined size.

3: The decontamination pellet of claim 2, wherein the outer casing is comprised of a substance that is less dense than the neutron core material.

4: The decontamination pellet of claim 3, wherein the outer casing has a predetermined melting point.

5: The decontamination pellet of claim 3, wherein upon exposure to air the outer casing becomes either semi-rigid or rigid yet remains pliable.

6: The decontamination pellet of claim 5, wherein the neutron core can be configured into an elongated fiber strand.

7: The decontamination pellet of claim 6, wherein the outer casing becomes sticky, yet retains its integrity, upon exposure water.

8: The decontamination pellet of claim 6, wherein the outer casing becomes sticky, yet retains its integrity, upon exposure to a predetermined temperature.

9: A method for the formation of neutron absorbing decontamination pellets, the method comprising the steps of:
creating a slurry comprised of a predetermined neutron absorber material and a binding agent;
transporting the slurry through a feeder hose, the hose terminating at a deposit nozzle;
employing the deposit nozzle to form the slurry into neutron cores of predetermined sizes;
immersing the neutron cores formed by the deposit nozzle into a bath of a predetermined insoluble polymer solution to create an outer casing upon each immersed neutron core in order to construct a neutron absorbing decontamination pellet, and
exposing the neutron absorbing decontamination pellets to air to dry, and thereafter transferring the dry decontamination pellets to storage.

10: The method of claim 9, further comprising the step of adding the decontamination pellets into a predetermined solution that will act as a delivery mechanism for the decontamination pellets.

11: The method of claim 10, wherein the outer casing of the decontamination pellets are comprised of a substance that is less dense than the slurry comprised of the neutron absorber material and binding agent.

12: The method of claim 11, wherein the deposit nozzle can be configured to form the slurry into an elongated fiber strand.

13: The method of claim 12, wherein the outer casing becomes sticky, yet retains its integrity, upon exposure water.

14: The method of claim 12, wherein the outer casing becomes sticky, yet retains its integrity, upon exposure to a predetermined temperature.
